(19) United States
(12) Patent Application Publication
(10) Pub. No.: US 2016/0327514 A1
(43) Pub. Date: Nov. 10, 2016

(54) CORRECTING SAMPLE METERING INACCURACY DUE TO THERMALLY INDUCED VOLUME CHANGE IN SAMPLE SEPARATION APPARATUS

(71) Applicant: Agilent Technologies, Inc., Santa Clara, CA (US)

(72) Inventors: Konstantin Shoykhet, Karlsruhe (DE); Klaus Witt, Keltern (DE)

(21) Appl. No.: 15/148,924

(22) Filed: May 6, 2016

(30) Foreign Application Priority Data
May 8, 2015 (GB) 1507900.7

(51) Int. Cl. G01N 27/447

(52) U.S. Cl. CPC G01N 27/44743

(57) ABSTRACT

A sample separation apparatus includes a metering device for metering a predefined amount of fluidic sample to be separated by a sample separation apparatus, a metering path for fluidically coupling the metering device and a sample source providing fluidic sample to be metered, and a control device. The control device is configured for controlling operation of the metering device for at least partially compensating for a deviation between a target value to be metered and an actual value of an amount of fluidic sample that is metered, the deviation resulting from a thermally induced volume change in the sample separation apparatus.

### RELATED APPLICATIONS

This application claims priority to UK Patent Application No. GB 1507900.7, filed May 8, 2015, titled “CORRECTING SAMPLE METERING INACCURACY DUE TO THERMALLY INDUCED VOLUME CHANGE IN SAMPLE SEPARATION APPARATUS,” the content of which is incorporated herein by reference in its entirety.

### BACKGROUND ART

The present invention relates to a control device for and a method of controlling a metering device for metering fluidic sample to be separated by a sample separation apparatus, and relates to a sample separation apparatus.

In liquid chromatography, a fluidic sample and an eluent (liquid mobile phase) may be pumped through conduits and a separation unit such as a column in which separation of sample components takes place. The column may comprise a material which is capable of separating different components of the fluidic sample. The separation unit may be connected to other fluidic members (like a sampler or an injector, a detector) by conduits. Before a plug of the fluidic sample is introduced into a separation path between a fluid drive unit (in particular a high pressure pump) and the separation unit, a predefined amount of fluidic sample shall be intaken from a sample source (such as a sample container) via an injection needle into a sample loop by a corresponding movement of a piston within a metering device. This usually occurs in the presence of a significantly smaller pressure than what the separation unit is run with. Thereafter, an injector valve is switched so as to introduce the intaken amount of fluidic sample from the sample loop of a metering path into the separation path between fluid drive unit and the separation unit for subsequent separation.

U.S. Pat. No. 8,297,936 assigned to the same applicant Agilent Technologies, Inc. discloses a method for controlling movement of a piston in a metering device which comprises supplying a fluid—with the goal of a continuous and precise flow—by actuating the metering device's piston, wherein compression or expansion of the fluid causes corresponding temperature variations. The method further comprises superposing a corrective movement onto the piston movement, with the corrective movement at least partly compensating for at least one of thermal expansion and contraction of the fluid induced by the temperature variations.

Although U.S. Pat. No. 8,297,936 has improved operation of a sample separation apparatus significantly, further increase of the quantitative accuracy in sample separation is desirable.

### DISCLOSURE

It is an object of the invention to enable sample separation and evaluate its components quantitatively with a high precision and accuracy.

According to an exemplary embodiment of the present invention, a control device (such as a processor) for controlling an exact amount intaken by a metering device (such as a piston pump or a syringe pump) for metering a predefined amount of fluidic sample to be introduced and then separated by a sample separation apparatus is provided, the sample separation apparatus comprising the metering device and a metering path for (in particular temporarily) fluidically coupling the metering device and a sample source (such as a sample container, for instance a vial, wherein the sample source may be also another fluid path, another loop or the like) providing (in particular containing) fluidic sample to be metered, wherein the control device is configured for controlling operation of the metering device for at least partially compensating for a deviation between a target value (which may, for instance, be set by a user or defined by a chromatographic method to be executed by the sample separation apparatus) to be metered and an actual value of an amount of fluidic sample that is metered, the deviation resulting from a thermally induced (i.e. caused by a temperature change) volume change (in particular a change of at least one of the internal volume of the sample separation apparatus or a part thereof; and/or a change of a specific volume of the fluid enclosed in the sample separation apparatus or a part thereof; and/or a change of a specific volume of the sample fluid itself) in at least part of the sample separation apparatus (in particular a thermally induced volume change of at least one hardware component of the sample separation apparatus and/or a thermally induced volume change of fluid comprised in the sample separation apparatus), in particular in at least part of a sample injector (wherein the metering device and the metering path may form part of the sample injector) of the sample separation apparatus.

According to another exemplary embodiment of the present invention, a sample separation apparatus for separating a fluidic sample into a plurality of fractions is provided, wherein the apparatus comprises a fluid drive unit configured for driving a fluid comprising a mobile phase and the fluidic sample in the mobile phase along a separation path, a separation unit arranged within the separation path and configured for separating the fluidic sample into the plurality of fractions, and an injector for introducing the fluidic sample between fluid drive unit and separation unit, the injector comprising a metering device for metering an exact amount of fluidic sample and a control device having the above-mentioned features for controlling the metering device.

According to another exemplary embodiment of the present invention, a method of controlling a metering device for metering a predefined amount of fluidic sample to be separated by a sample separation apparatus is provided, the sample separation apparatus comprising the metering device and a metering path for fluidically coupling the metering device and a sample source providing fluidic sample to be metered, wherein the method comprises controlling operation of the metering device for at least partially compensating for a deviation between a target value to be metered and an actual value of an amount of metered fluidic sample, the deviation resulting from a thermally induced volume change in at least part of the sample separation apparatus, in particular in at least part of a sample injector of the sample separation apparatus.

In the context of this application, the term “fluidic sample” may particularly denote any liquid and/or gaseous medium, optionally including also solid particles, which is to be analyzed. Such a fluidic sample may comprise a plurality of fractions represented by molecules or particles which shall be separated, for instance small mass molecules or large mass biomolecules such as proteins. Separation of a fluidic sample into fractions may involve a certain separation criterion (such as mass, volume, chemical properties, etc.) according to which a separation can be carried out.

In the context of this application, the term “sample separation apparatus” may particularly denote any apparatus which is capable of separating different fractions of a fluidic sample by applying a certain separation technique. The actual separation can be carried out in a separation unit of the sample separation apparatus. The term “separation unit” may particularly denote a member of a fluidic path through which a fluidic sample is transferred and which is configured so that, upon conducting the fluidic sample through the separation unit, fractions or groups of molecules of the fluidic sample will be at least partly spatially separated according to the difference in at least one of their properties. An example for a separation unit is a liquid chromatography column which is capable of trapping or retarding and selectively releasing different fractions of the fluidic sample.

According to an exemplary embodiment, a control of a sample metering operation of a sample separation apparatus may take into account the impact of a change of an internal fluid accommodation volume within the sample separation apparatus and/or of fluid itself (such as fluidic sample and/or mobile phase) in the sample separation apparatus, in particular a sample injector thereof, as a consequence of a temperature change. Such a temperature change may for instance be caused by a transition between a high pressure condition (for instance at least 1000 bar) during sample separation of the metered fluidic sample in a separation path (into which the metered fluidic sample is to be introduced) between a mobile phase drive and a separation unit and a low pressure condition (for instance at or close ambient pressure) during a metered sample intake. Apart from the thermally induced contraction or expansion of the fluidic sample and mobile phase due to its temperature change within the injector (or more generally within the sample separation apparatus) once the said fluid is out of thermal equilibrium with the sample path of the sample separation apparatus or the temperature of the said sample path varies itself, the value of the interior fluid accommodating volume of the injector itself (or more generally of the sample separation apparatus itself) can be significantly changed under thermal load. It has turned out that the accuracy of metering fluidic sample, and as a consequence the quantitation accuracy and precision of the sample separation result, may be remarkably improved by considering thermal volume changes during sample metering, especially when handling smaller sample volumes.

In the following, further exemplary embodiments of the control device, the sample separation apparatus, and the method will be explained.

In an embodiment, the control device is configured for adjusting a drive mechanism operation (comprising e.g. a motor, for instance an electric motor) for driving a reciprocating piston of a piston pump-type metering device within a piston chamber for at least partially compensating for the described volume deviation. Normally, the drive mechanism executes a regular motion pattern to intake a predefined nominal amount of fluidic sample (corresponding to a piston size and motion from a starting position within the piston chamber to a final position in the piston chamber). In the event of thermally induced artifacts, such as deviation resulting from a temperature related modification of the interior volume of the sample separation apparatus and/or the fluid, however, the motion pattern can be correspondingly adjusted to modify the piston positions or piston trajectory over time as a correction. For instance, stroke length, starting position and/or final position of the piston in the piston chamber may be adapted. Merely adapting a piston drive is a very simple measure for carrying out the correction, usually resolution is given (for other performance reasons). It is also a compact solution since it does not require extensive hardware effort for the volumetric compensation. In another embodiment, the control device controls a compensation drive unit, comprised in the sample separation apparatus and at least intermittently fluidically connected to the metering path, for at least partially compensating for the deviation, in addition to the metering device driving the fluidic sample. In yet another embodiment, the control device comprises a temperature adjustment unit for at least partially compensating for the deviation by actively adjusting temperature in at least part of the sample separation apparatus. The mentioned embodiments can also be combined.

In an embodiment, the control device is configured for adding a backward displacement component to the motion of the piston in the piston chamber in the event of a thermally induced increase of the volume occupied by fluid (in particular mobile phase and/or fluidic sample) in the sample separation apparatus, in particular in the metering device and the metering path (with other words: thermal expansion volume of the fluid gets accommodated within the metering path, due to this a backward displacement component of the piston motion). Additionally or alternatively, the control device may be configured for adding a forward displacement component to the motion of the piston in the piston chamber in the event of a thermally induced decrease of the volume occupied by the fluid in the sample separation apparatus, in particular in the metering device and the metering path. Additionally or alternatively, the control device may be configured for adding a backward displacement component to the motion of the piston in the piston chamber in the event of a thermally induced decrease of the internal volume constrained by walls and/or boundaries of a fluid path in the sample separation apparatus, in particular in the metering device and the metering path. Additionally or alternatively, the control device may be configured for adding a forward displacement component to the motion of the piston in the piston chamber in the event of a thermally induced increase of the internal volume (or space) constrained by the walls and/or boundaries of the fluid path in the sample separation apparatus, in particular in the metering device and the metering path. In this context, a backward displacement relates to a motion of the piston by which the piston normally intakes or draws in fluidic sample. A forward displacement relates to a motion of the piston by which the volume enclosed in the piston chamber is reduced. Thus, an additional backward displacement (which may increase the piston stroke) relates to an increased intake of fluidic sample for correction purposes, whereas an additional forward displacement (which may correspond to a reduced backward displacement or may decrease the piston stroke) relates to a decreased intake of fluidic sample for correction purposes (for instance in the case in which a zero amount of fluid shall be drawn, the following consideration may be made: after a high pressure condition, a valve switches to a bypass mode; this reduces the pressure in the metering path and leads to a rapid cool down of the fluid; subsequently, the fluid warms up again and expands; during this time, the piston moves back so that no fluid is ejected at the needle). More particularly, when the interior volume of the injector is heated (is cooled), its fluidic content expands (contracts) so that a non-modified (or non-adjusted) backward motion of the piston results in a reduced (an increased) amount (expressed as mass, number of moles, number of molecules or similar) of intaken fluidic sample. For compensation, an additional backward (forward) motion has therefore to be added to obtain the correct amount of metered fluidic sample. When the interior injector volume is heated (is cooled), its fluidic content expands (contracts) resulting in a reduced (increased) amount of intaken fluidic sample. These kind of effects shall be compensated for partially or entirely according to exemplary embodiments of the invention. The impact of volume changes of an internal volume of the sample injector and of volume changes of fluid within the sample injector in the event of an increase of the temperature or a decrease the temperature, i.e. in four different cases, may be different and may be compensated for altogether.

In a preferred embodiment, the deviation (i.e. the difference between target value to be metered and actual value that is metered), which is to be at least partially compensated for, results from a thermally induced volume change in (in particular in a space within and a fluid occupied volume within) the metering device (in particular the interior volume of the piston chamber) and the metering path (in particular the interior volume of fluidic conduits and a sample loop), in particular in the entire metering device and the entire metering path. Hence, both volume changes in the housing and of the liquid content may be considered. Hence, preferably the complete hollow and/or fluid-filled interior volume of the metering or sampling path (more specifically, the entire volume prone to the temperature variation, due to either pressure changes or to the heat transfer from the material, such as fluid, undergone the pressure change) may be taken into account for the compensation. Thus, the compensation may be carried out considering specifically effects within a fluid accommodating interior volume of the sample injector where a lever effect (i.e. an effect according to which a small cause has a high impact, see explanation below) on intake deviations is particularly pronounced. Optionally, also deviations caused by thermally induced contraction or expansion of fluidic sample accommodated within the mentioned interior may be considered and suppressed by a corresponding correction. Since the interior injector volume (for instance several hundred microliters) for accommodating fluid may be many times (or even several orders of magnitude) larger than a typical volume of fluidic sample to be metered (for instance below ten microliters), metering path born volumetric artifacts may result in deviations of the amount of fluid to be metered being very significant. Thermally caused changes of such a large volume in comparison with much smaller absolute values of a volume of sample to be metered act in a similar way as a mechanical lever. In other words, deviations of the volume of the metered fluidic sample (wherein also the absolute temperature can be considered) due to its own thermal expansion or contraction (or shrinkage) may be much smaller than deviations of the volume of the metered fluidic sample due to thermal expansion or contraction (or shrinkage) of the interior volume of metering device and metering path during the metering process, that is during the phase, when the sample material is being intaken into the part of the fluid path serving as sample loop. To explain it more precisely, the metered volume deviation (if not corrected) will be determined by on one hand deviation of the sample fluid's own temperature (and thus specific volume) when intaken from a reference temperature (a relatively small deviation although the temperature deviation might be substantial) and, on the other hand by an additional intaken or expelled volume within the fluidic sample is being drawn (and occasionally transported), which is caused by the total change of the volume within the metering path caused by a dynamic temperature change within the sample path within the time span of the sample intake phase. This latter deviation might be significant, although caused by a relatively small temperature change, due to large total volume enclosed in the metering path. According to an exemplary embodiment, this undesired influence of the described volume lever on the accuracy and precision of metered sample fluid is at least partially compensated for by correspondingly correcting the metering procedure. As a result, the metered amount of fluidic sample may be rendered more accurate, which, in turn, results in a more precise, reliable and reproducible result of a separation analysis. This effect becomes more and more considerable in view of the modern trend of decreasing the volume of fluidic sample, resulting in an increasingly strong impact on the lever ratio, and of increasing the throughput of the analytical instrumentation, shortening the time span between the pressure changes in the fluidic path and the sample intake phase, thus making temperature variation in the metering path during the intake phase more pronounced (larger and steeper).

More precisely, in an injector of the sample separation apparatus, the interior injector volume (for instance in the order of magnitude of 100 μl to 1000 μl) of a piston chamber of the metering device, a sample loop of the metering path, connected fluidic conduits of the metering path as well as an interior volume of an injection needle may be significantly larger than a targeted sample volume to be proportioned (for instance in the order of magnitude of 1 μm). Consequently, thermally induced expansion or contraction (or shrinkage) of the interior injector volume may be quantitatively much more pronounced than thermally induced expansion or contraction of the sample volume. Thus, a relatively small temperature change (for instance 1° C.) of the injector may have a significantly larger impact on a discrepancy of an amount of metered fluidic sample than a much larger temperature change (for instance 10° C.) of the metered fluidic sample. This can be denoted as a fluidic lever effect.

In an embodiment, the control device is configured for carrying out the compensation under consideration of a thermal conductivity, a heat capacitance, and/or a coefficient of thermal expansion (CTE) of the metering device, the metering path (in particular a sample loop in the metering path for temporarily accommodating the metered fluidic sample) and/or the sample source. Also respective parameters of the fluid may be taken into account. Corresponding material parameters which may be used by the control device as a basis for the correction may be stored in a database accessible for the control device. For the compensation of volumetric inaccuracies, it may hence be advantageous to know and consider properties of the fluidic sample (such as thermal conductivity, heat capacity, coefficient of thermal expansion, time behavior, temperature upon adiabatic expansion, etc.) and of the hardware components (such as piston) of the injector (for instance coefficient of thermal expansion, heat capacitance, thermal conductivity, etc.). In an embodiment, not only volume changes of the metered fluidic sample may be taken into account, but also effects resulting from volume changes of other fluids (in particular mobile phase) present in the sample injector can be advantageously considered for the compensation. It may then be analyzed how the interior injector volume behaves during sample intake, to allow to predict reaction of the injector volume in response to thermal changes. The metering device may then be controlled in such a way that the predicted volumetric reaction on temperature changes is compensated for.

In an embodiment, the control device is configured for predicting an expected (such as a future) deviation and for correcting or at least partially compensating for the expected deviation before its actual occurrence. Such a prediction can be made based on a model of the thermally induced volumetric modification phenomena within an interior of the sample separation apparatus which allows to calculate expected artifacts in advance and to correct piston movement prior to the actual appearance of the deviation. Basis of a correction may be also an empirical analysis of the measured metering accuracy in dependence of the magnitude of the foregoing pressure change, time span between the pressure change and the sample intake, sample intake duration, thermodynamic properties of the fluid(s) within the metering path and geometry and physical properties of the components of the metering path.

In an embodiment, the control device is configured for detecting a present deviation and for correcting or at least partially compensating for the present deviation to guide the (not entirely correct) actual value of the amount of fluidic sample towards the ideal target value. In this embodiment, upon detecting an actual distortion, the latter may be detected (for instance by suitably arranged temperature and/or pressure and/or flow rate sensors), and rapid countermeasures may be taken.

In an embodiment, the control device is configured for at least partially compensating for the deviation by superposing (or time-close application) a corrective piston movement during a process of drawing a metered amount of fluidic sample from the sample source into a sample loop in the metering path between the metering device and the sample source. In case in which a piston pump is used as a metering device, the adaptation of the motion pattern applied to the piston may be sufficient to carry out the compensation.

In an embodiment, the control device is configured for at least partially compensating for the deviation based on a temperature over time characteristic of the metered fluidic sample. By comparing an actual amount of metered fluidic sample with a desired or defined amount of metered fluidic sample missing fluidic sample may be added or excessive fluidic sample may be removed.

In an embodiment, the control device is configured for at least partially compensating for the deviation based on a time dependence of the thermally induced volume change within the sample separation apparatus. When the time dependence of thermally induced volume change of the hardware components particularly of the sample injector of the sample separation apparatus is known (for instance is experimentally measured or theoretically modelled), this information may be used for a precise or refined correction.

In an embodiment, the control device is configured for at least partially compensating for the deviation based on sensor data received from the one or more dedicated sensors (such as at least one temperature sensor, and/or at least one pressure sensor, and/or at least one flow rate sensor, etc.), arranged at the metering device, the metering path and/or the sample source. Such sensor data allow an estimation of the present volumetric discrepancy. A sensor data supported correction has the advantage that the actual correction is carried out on an objective basis making use of physical data measured directly within the system to be corrected.

In an embodiment, the control device is configured for at least partially compensating for the deviation based on a model indicative of the fluidic behavior (for instance type of solvent or mixture of mobile phase) and energetic behavior of the system comprising preferably the metering device and the metering path, wherein also fluidic sample and/or sample source may be optionally considered. Additionally or alternatively to the above-described sensor approach, a theoretical model about the effects and phenomena within the interior volume of the sample separation apparatus (in particular of the injector) may be applied and consulted as a basis for determining a proper correction.

In an embodiment, the control device is configured for at least partially compensating for the deviation under consideration of a lever effect resulting from a difference between an interior volume of the metering device and the metering path on the one hand and the metered volume of the fluidic sample on the other hand. Since the former volume may be much larger (for instance at least one or more orders of magnitude larger) than the latter volume, thermal artifacts in the high-volume metering device and metering path may be much more pronounced than intra-sample artifacts. Taking into account this cognition concerning the lever effect for the correction has an enormous potential of increasing metering precision. More specifically, the sample volume is distorted (from the side of the lever) by an absolute amount independent on the sample volume itself. Thus, the correction may be dependent on a sum of a lever-born correction and a sample volume born adjustment.

In an embodiment, the control device is configured for metering a volume of fluidic sample of less than 50 μl, in particular of less than 10 μl, more particularly of less than 2 μl. With such small volumes of fluidic sample to be introduced into the separation path for subsequent separation (in particular by liquid chromatography), the considered metering artifacts due to thermal expansion or contraction of the sample separation apparatus (in particular the injector thereof, more particularly the entire metering path and the entire metering device of the injector and more specifically the fluidic content thereof) become a severe bottleneck limiting achievable separation accuracy. Thus, the discussed correction becomes highly advantageous in particular for such small sample volumes, since the above mentioned lever ratio may then become very high, even when only 10% of the original temperature dynamics is still active while the sample is taken.

In an embodiment, the control device is configured for at least partially compensating for the deviation under consideration of a pressure change in the metering path between a high pressure separation state during which the sample separation apparatus is characterized by a separation path being under high pressure, and a low pressure metering state (i.e. in which the pressure in the metering path is lower, for instance at or close to atmospheric pressure, than in the above mentioned high pressure separation state) during intaking fluidic sample from the sample source into the metering path by the metering device. Sudden pronounced pressure changes in the metering path during operation of the sample separation apparatus may have the order of magnitude of several hundred bar and may therefore also have a significant impact on the temperature and the internal volume of the hardware of and the fluid within the injector. Considering the impact of such pressure drops on hardware and fluid allows to obtain a more precise metering result. A reaction of the fluidic sample to be metered on such phenomena may be anticipated, and resulting or predicted volumetric discrepancies may be partially or completely corrected.

Thus, a typical succession may be as follows: Switching from high pressure to low pressure occurs, and fluid in the metering path cools down. The fluid heats up back to ambient temperature, the needle is driven towards and into the sample, intake begins. During intake, the fluid continues to heat up, thus the intaken volume gets reduced by the expansion volume of the metering path content during the intake phase. This can be corrected. Finally the sample is introduced; fluid is compressed and heated up, but this now no longer influences the sample amount, as the sample is already enclosed into the flow path.

In an embodiment, the control device is configured for controlling operation of the metering device for at least partially compensating for a deviation of the amount of fluidic sample to be metered resulting from a thermally induced volume change of the fluidic sample. Thermal expansion or thermal contraction or shrinkage of the fluid content and fluidic sample to be metered and introduced for subsequent separation may introduce an error. Considering this sample-related artifact, in particular in combination with the above-described apparatus-related artifact, allows to obtain a highly precise metering result.

Embodiments of the present invention may be embodied based on most conventionally available HPLC systems, such as the Agilent 1200 Series Rapid Resolution LC system or the Agilent 1100 HPLC series (both provided by the applicant Agilent Technologies—see www.agilent.com—which shall be incorporated herein by reference).

One embodiment comprises a pumping apparatus as fluid drive unit or mobile phase drive having a piston for reciprocation in a pump working chamber to compress liquid in the pump working chamber to a high pressure at which compressibility of the liquid becomes noticeable. This pumping apparatus may be configured to know (by means of operator's input, notification from another module of the instrument or similar) or elsewise derive solvent properties, which may be used to represent or retrieve actual thermal properties of fluidic content, which is anticipated to be in the sampling apparatus.

The separation unit preferably comprises a chromatographic column (see for instance http://en.wikipedia.org/wiki/Column_chromatography) providing the stationary phase. The column may be a glass or steel tube (for instance with a diameter from 50 μm to 5 mm and a length of 1 cm to 1 m) or a microfluidic column (as disclosed for instance in EP 1577012 or the Agilent 1200 Series HPLC-Chip/MS System provided by the applicant Agilent Technologies, see for instance http://www.chem.agilent.com/Scripts/PDS.asp?IPage=38308). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, surface modified silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface.

The mobile phase (or eluent) can be either a pure solvent or a mixture of different solvents (such as water and an organic solvent such as ACN, acetonitrile). It can be chosen for instance to minimize the retention of the compounds of interest and/or the amount of mobile phase to run the chromatography. The mobile phase can also be chosen so that the different compounds or fractions of the fluidic sample can be separated effectively. The mobile phase may comprise an organic solvent like for instance methanol or acetonitrile, often diluted with water. For gradient operation water and organic is delivered in separate bottles, from which the gradient pump delivers a programmed blend to the system. Other commonly used solvents may be isopropanol, tetrahydrofuran (THF), hexane, ethanol and/or any combination thereof or any combination of these with aforementioned solvents.

The fluidic sample may comprise but is not limited to any type of process liquid, natural sample like juice, body fluids like plasma or it may be the result of a reaction like from a fermentation broth.

The pressure, as generated by the fluid drive unit, in the mobile phase may range from 2-200 MPa (20 to 2000 bar), in particular 10-150 MPa (100 to 1500 bar), and more particularly 50-120 MPa (500 to 1200 bar).

The sample separation apparatus, for instance an HPLC system, may further comprise a detector for detecting separated compounds of the fluidic sample fluid, a fractionating unit for outputting separated compounds of the fluidic sample, or any combination thereof. Further details of such an HPLC system are disclosed with respect to the Agilent 1200 Series Rapid Resolution LC system or the Agilent 1100 HPLC series, both provided by the applicant Agilent Technologies, under www.agilent.com which shall be incorporated herein by reference.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 illustrates a sample separation apparatus according to an exemplary embodiment of the invention.

FIG. 2 shows a pump and a sample injector according to an exemplary embodiment.

The illustration in the drawing is schematic.

### DETAILED DESCRIPTION

Before describing the figures in further detail, some basic considerations of the present inventors will be summarized based on which exemplary embodiments have been developed.

According to an exemplary embodiment of the invention, thermal expansion and/or contraction may be considered while controlling movement of a piston of a metering device for improved accuracy in volumetric action (in particular for rendering proportioning of a fluidic sample volume to be metered more accurate).

When considering faster cycle times for liquid chromatography (LC) equipment, which is a subject matter especially in U-HPLC (Ultra High Performance Liquid Chromatography), and equipment for other sample separation apparatuses, it turns out that some historic implementations may unveil their limitations. This is specifically pronounced when at the same time the sample volumes are reduced.

For reasons like improved resolution, enhanced speed of analysis and overlapped execution for sample throughput and because in modern application fields, like bio-pharma research, the total sample amount often is limited, there is a natural move for the user to inject less amount per liquid chromatography separation run (thereby decreasing sample volume), but still run analytical measurements in a dense cycle rate. It is possible to inject just a small amount (of for instance 1 μl), and still it is expected by users that performance, especially precision but also accuracy of the introduced amount, is not deteriorated. But at the same time the total analysis or cycling rate is expected to be as short as e.g. 15 seconds. While there is a trade-off in sensitivity for saving sparse sample, still a user expects same the performance for reproducibility, linearity and accuracy in quantitation.

However, injection performance is limited at this lower end of injection ranges. Whereas this decrease in precision may have a number of reasons typical for handling small fluid volumes, one specific may gain a critical role when at the same time the time interval between a pressure change (which occurs during discharge) in the sample metering path and the sample intake procedure becomes shorter and enters the single-digit-seconds range.

Pressure dynamics may be considered anticipating resulting thermal effects to improve performance. This may involve anticipating temperature increase during compression and the resulting overpressure in a closed chamber, but often it is forgotten that releasing the pressure also will result in a temporary temperature decrease. Truly this effect is solvent dependent, and normal experience may be misleading (masking adverse effects) simply because technical tests may be done under non-critical conditions, while the end customer application has to address different needs. Hence, the problem may disguise for long (making it even more problematic). When the checkout is done with aqueous mixtures in the loop, then the volumetric effect may be 20× lower than with e.g. acetonitrile when running HILIC (hydrophilic interaction liquid chromatography) applications.

Referring to the liquid component in this context, the solvent dependency involves the following aspects:

a) the resulting temperature increase/decrease on pressure variation

b) the thermal expansion of fluid volume on temperature variation

c) on top of that, the heat capacity of the tubing, cylinder walls, pistons etc. have also an impact, because these technical parameters influence the secondary (longer term) course of the temperature in the therein contained liquid. In this context, it is remarkable that this solvent behavior is basically reversible. While temperature increases on compression, it will likewise decrease when the pressure is released.

However, it should be understood that fluid behavior is basically reversible. While temperature increases on compression, temperature will likewise decrease when the pressure is released. Moreover, volumetric expansion of fluid is a function of temperature and of the respective solvent (for example ˜0.03%/K for water, ˜0.12%/K for organic solvents; volumetric expansion coefficients are typically positive; the given values are approximate values for typical ambient conditions, however they are dependent on solvent type and absolute temperature level). It is easily possible to predict that the effect can stretch some 50 times across different solvents in use.

Now reference is made to the volumetric component in this context.

In the following, a hydraulic configuration will be described which holds for many liquid chromatography products. Thinking about the critical conditions of introducing as little a volume as possible of a fluidic sample to be metered of for instance 1 μl, this absolute amount can be compared to the dynamic amount in the flow path as the total loop path volume “valve port-to-valve port” or “valve port-to-needle tip” (i.e. the interior volume of metering path and metering device). As a rule of thumb, it is reasonable to assume an injector system with following configuration:

capability to operate at 1000 bar

capability to inject a volume of not more than 40 μl

use of a 40 μl metering device (add 50 μl when considering dead volume)

80 μl volume of the sample loop (see velocity profile in open pipes)

an additional volume of 10 μl for valve connections

A calculation for less critical solvents (such as aqueous solvent) results in a deviation of:

1000bar*0.18K/100bar*0.03%/K=0.05%

A calculation for more critical solvents (such as an organic solvent, for example acetonitrile, ACN) results in a deviation of:

1000bar*2K/100bar*0.12%/K=2.4%

However, a specific aspect has to be considered which is here denoted as the volume lever effect, since it relates to a physical phenomenon which has a small input value and a large output value and therefore acts similar to a lever in a mechanical analogue: This deviation factor (2.4% in the latter case) is not working or operating on the injection volume alone. It is acting on the total volume in the sample path or metering path (50 μl+80 μl+10 μl=140 μl) while metering, i.e. in the above-mentioned case 140 μl in comparison to a 1 μl volume of the fluidic sample to be metered. This means that there is a dynamic volume of, for instance, up to approximately 3 μl. Even when considering that this thermal pulse may decay fast, for example with a time constant of 2 seconds, given a time span ‘pressure discharge-to-sample intake’ of some 5 seconds, there will be a substantial effect left when considering 1 μl total to be metered. In other words, once one is striving for 1% precision when sampling 1 μl liquid, a maximum of 10 nl intake volume variation is allowed. 10 nl is 0.006% of the estimated 140 μl buffer volume. Even in an uncritical case of pure aqueous sampling path content, it corresponds to a temperature change or temperature variation of 200 mK. This is the permitted mean temperature change within the sampling path for the duration when the needle is immersed into the sample liquid. Coming down from 1000 bar it will be only after 2.2 times the temperature decay time constant past decompression, that the temperature will differ from equilibrium by less than 200 mK. That is after 4.4 seconds, assuming a temperature decay constant of 2 seconds. Increasing organic content in the metering path makes the situation over-proportionally more critical due to both greater temperature change and stronger effect of the temperature change on volume. For the case of pure methanol or ACN one could only allow 0.05K temperature variation during sample intake whereas the initial temperature deviation is roughly 14 times greater than for water. This results in roughly 6.2 times the temperature decay time, which may easily take 10 seconds or a longer time-out.

Consequently, one aspect according to an exemplary embodiment of the invention is to anticipate the solvent/sample reaction to the pressure release and compensate for the subsequent growth in volume caused by the fluid heating back to the ambient temperature by adding an adequate extra displacement in order to adjust for the correct volume to be picked up from the sample source or to report the corrected pulled sample volume back, that is to admit the system behaving differently than commanded. Otherwise the adequate sample intake is only possible after a more or less long time-out after pressure discharge from the sample metering path.

In an embodiment, it is hence advantageous to consider at least one of the following aspects:

For the magnitude (impact): the actual system pressure in the injector, and/or the net liquid volume, and/or the solvent composition that is involved (the pump may “know” the solvent type and the mixture).

For the timing in relation to the sample contact: the geometric distribution of the solvent, and/or the thermal properties of the flow conduits (such as tubes, syringe, etc.), and/or the timing relation “valve-switch to needle-motion”, and/or the influence of distance to sample location.

Other aspects to consider relate to one or more of the following: the question as to whether the syringe is included into the high pressure flow path (and undergoes the pressure changes) or not; the question as to whether the mobile phase carries thermal energy and how much (if the mobile phase has a temperature different from the ambient within the sample injector); the question as to whether the metering device introduces temperature deviation; the temperature of the sample and/or the sample source; the question as to whether the sample is being cooled or otherwise kept at a temperature different from that of the mobile phase or of the sample loop and path and its immediate environment; solvent properties of the fluidic sample itself.

It should be mentioned that it is possible to construct conditions in which the described thermal artifact introduces more mobile phase into the sample receptacle than the volume it will actually pick for sampling.

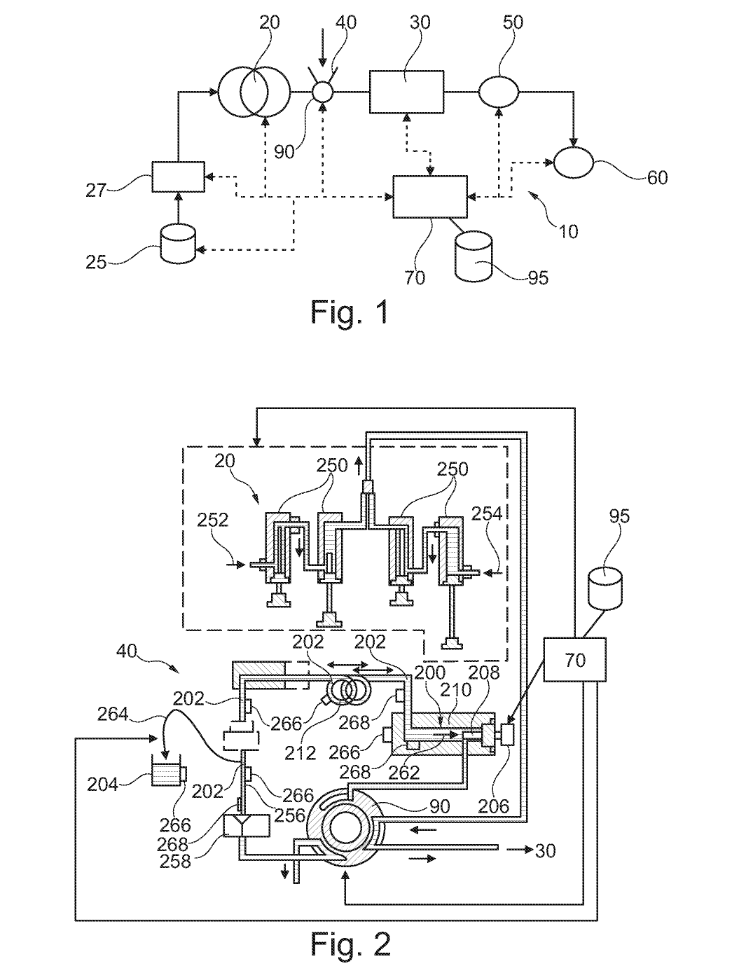

Referring now in greater detail to the drawings, FIG. 1 depicts a general schematic of a sample separation apparatus 10. A high pressure pump as a fluid drive unit 20 receives a mobile phase from a solvent supply 25, typically via a degasser 27, which degases the solvent and thus reduces the amount of dissolved gases in the mobile phase. The fluid drive unit 20 drives the mobile phase through a separation unit 30 (such as a chromatographic column) comprising a stationary phase. A sampling unit or sample injector 40 (compare the detailed description of FIG. 2) can be provided between the mobile phase drive or fluid drive unit 20 and the separation unit 30 in order to subject or add (often referred to as sample introduction) a fluidic sample into the mobile phase. A fluidic valve (or a combination of valves) denoted as injector valve 90 is switchable between different switching positions (or combinations of positions), one of which relates to an intake of fluidic sample within the sample injector 40 at a low pressure (see detailed description of FIG. 2), while another switching position relates to an introduction of previously intaken fluidic sample into a main path or separation path between fluid drive unit 20 and separation unit 30 for separation of the fluidic sample under high pressure provided by the fluid drive unit 20. The stationary phase of the separation unit 30 is configured for separating compounds of the sample liquid. A detector 50 is provided for detecting separated compounds or fractions of the fluidic sample. A fractionating unit 60 can be provided for collecting separated compounds of fluidic sample individually.

While the mobile phase can be comprised of one solvent only, it may also be mixed from plural solvents. Such mixing might be a low pressure mixing and provided upstream of the fluid drive unit 20, so that the fluid drive unit 20 already receives and pumps the mixed solvents as the mobile phase. Alternatively, the fluid drive unit 20 may be comprised of plural individual pumping units, with plural of the pumping units each receiving and pumping a different solvent or mixture, so that the mixing of the mobile phase (as received by the separation unit 30) occurs at high pressure and downstream of the fluid drive unit 20 (or as part thereof). The composition (mixture) of the mobile phase may be kept constant over time, the so called isocratic mode, or varied over time, the so called gradient mode.

A data processing unit or control device 70, which can be a PC or workstation or an instrument-embedded micro-processor, can be coupled (as indicated by the dotted arrows) to one or more of the devices in the sample separation apparatus 10 in order to receive information and/or control operation. For example, the control device 70 may control operation of the fluid drive unit 20 (for instance setting control parameters) and receive therefrom information regarding the actual working conditions (such as output pressure, flow rate, etc. at an outlet of the pump). The control device 70 may also control operation of the solvent supply 25 (for instance setting the solvent/s or solvent mixture to be supplied) and/or the degasser 27 (for instance setting control parameters such as vacuum level) and may receive therefrom information regarding the actual working conditions (such as solvent composition supplied over time, flow rate, vacuum level, etc.). The control device 70 may further control operation of the sample injector 40 (for instance controlling sample injection or synchronization of sample injection with operating conditions of the fluid drive unit 20). The separation unit 30 may also be controlled by the control device 70 (for instance selecting a specific flow path or column, setting operation temperature, etc.), and send—in return—information (for instance operating conditions) to the control device 70. Accordingly, the detector 50 may be controlled by the control device 70 (for instance with respect to spectral or wavelength settings, setting time constants, start/stop data acquisition), and send information (for instance about the detected sample compounds) to the control device 70. The control device 70 may also control operation of the fractionating unit 60 (for instance in conjunction with data received from the detector 50) . The injector valve 90 is also controllable by the control device 70 for selectively enabling or disabling specific fluidic paths within sample separation apparatus 10.

The control device 70 can read data from and can write data in a database 95.

Detailed operation of the control device 70, in particular concerning the control of the injector 40 and its components (in particular metering device 200 of injector 40), will be described referring to FIG. 2.

It is understood that the control device 70 may be a concerted effort of distributed control instances, which can communicate. Multiple embedded controllers may work together in performing a common task. Thus the control device 70 may be a computer, tablet, smartphone or specialized processor or controller as a remote instance (e.g. connectable wirelessly or over intra- or internet), or a local instance (e.g. connectable immediately to the instrument via a dedicated hardware interface, such as RS232, RS484, CAN, etc.), or an internal instance, such as a controller or processor built-in in the instrument or one of its modules, or a distributed instance comprising one or plurality of the controllers of any of the types mentioned above.

FIG. 2 shows sample injector 40 and related upstream fluidic components of sample separation apparatus 10 according to an exemplary embodiment of the invention.

The sample injector 40 is configured to meter a predefined amount of fluidic sample and to subsequently introduce the metered amount of fluidic sample into a mobile phase or more precisely into the flow path of the mobile phase. The mobile phase is driven by fluid drive unit 20. In a certain switching state (not shown here) of injector valve 90, the fluid drive unit 20 drives the metered fluidic sample together with mobile phase through separation unit 30 for separating compounds of the fluidic sample in the mobile phase. To provide these functions, the sample injector 40 comprises a metering device 200 which is embodied as a piston pump with a piston 208 being mounted in a piston chamber 210 for reciprocating therein, i.e. moving forwardly or backwardly, to thereby displace fluid. A drive mechanism 206 (which may comprise an electric motor) drives the piston 208. The metering device 200 is configured for intaking a proportioned or metered amount of the sample fluid into the sample injector 40.

Hence, FIG. 2 illustrates part of sample separation apparatus 10 having a fluid supply provision in form of a high pressure mixing type binary pump as mobile phase drive or fluid drive unit 20. In the shown example, the binary pump is a pump having two channels (see reference numeral 252, 254) constituted of four high pressure piston pump units 250. Thus, the fluid drive unit 20 is an example for a configuration capable of pumping a variable mixture of two different solvents (such as water and an organic solvent) towards the injector valve 90.

In the switching position of the injector valve 90, as shown in FIG. 2, a direct fluidic connection from the fluid drive unit 20 through the injector valve 90 towards the separation unit 30 is established. In this switching position, the sample intake part of the injector 40 is fluidically decoupled from the fluid drive unit 20. In this switching position shown in FIG. 2, an injection needle 256 can be moved (for instance by a not shown robot and under control by the control device 70) out of a corresponding needle seat 258 and can be immersed into a sample source 204 (see arrow 264), which in the shown embodiment is a sample container containing fluidic sample. During the immersion, metering path 202 fluidically couples the metering device 200 and the sample source 204 containing fluidic sample to be metered. Subsequently, piston 208 of the metering device 200 can be retracted or moved backwardly, as indicated by an arrow 262, thereby intaking or drawing sample fluid from the sample source 204, via the injection needle 256 into fluid accommodation volume 212 or sample loop of a metering path 202. The metering path 202 comprises the fluid accommodation volume 212 and connected fluidic conduits (more precisely a fluidic conduit fluidically connecting the metering device 200 with the fluid accommodation volume 212, a further fluidic conduit fluidically connecting the fluid accommodation volume 212 with the injection needle 256, and an internal volume of the injection needle 256 itself). Since the piston 208 moves back along a predefined length within the piston chamber 210, a corresponding predefined metered amount of fluidic sample is drawn into the fluid accommodation volume 212.

After this metering procedure, the injector 40 serves for introduction of the intaken sample fluid from the fluid accommodation volume 212 into a separation path (also denoted as main path) between the mobile phase drive 20 and the separation unit 30. For this purpose, the control device 70 may control the injector valve 90 to be switched into a switching position in which the mobile phase drive 20 pumps a solvent composition as mobile phase through the injector valve 90, the metering device 200, the metering path 202 (including the sample accommodation volume 212 and connected fluidic conduits), the injection needle 256, the needle seat 258 (now accommodating the injection needle 256 which has meanwhile been driven back into the needle seat 258, for instance by the robot under control of the control device 70), the injector valve 90 and from there to the separation unit 30.

The control device 70, as already discussed above referring to FIG. 1 and as shown in FIG. 2, controls and synchronizes operation of fluid drive unit 20 and injector 40 including its components (in particular drive mechanism 206 and needle robot).

The function of the control device 70 in terms of compensating for thermally induced volumetric discrepancies of an amount of metered fluidic sample will be described in the following in detail:

The control device 70 is configured for controlling operation of the metering device 200 for at least partially compensating for a deviation between a predefined target value and a real actual value of an volumetric amount of fluidic sample to be metered, which deviation may result from a thermally induced volume change within the metering path 202 and the metering device 200 of the injector 40 of the sample separation apparatus 10 during the immersion phase of the injection needle 256 into the sample source 204. Thus, the mentioned hardware components as well as fluid therein may expand or contract in the event of temperature changes without degrading performance of the sample separation apparatus 10 due to the compensatory action controlled by the control device 70. Change of internal volume of the metering path 202 and the metering device 200 is considered as a major source for incorrect metering, since these volume artifacts may cause the above described lever effect on the metered fluidic sample. Additionally, a deviation of the amount of metered fluidic sample caused by a thermal expansion or thermal contraction of the fluidic sample itself may be considered for the correction to obtain high accuracy. Thus, due to effects like thermal expansion or contraction, pressure change induced temperature changes, temperature equilibration procedures, etc., it may happen that hardware components delimiting the metering path 202 and the metering device 200 and/or fluid within the metering path 202 and/or within the sample source 204 change their dimensions, densities or volumes as compared to expected values, thereby causing artifacts during the above described sample intake procedure and fluid processing procedure. Consequently, the sample separation procedure may be rendered inaccurate which may have a negative impact on the precision, reliability and reproducibility of the sample analysis. Since the internal volume of the metering device 200 and the metering path 202 can be significantly larger than the volume of the metered fluidic sample, thermal effects changing the value of the interior volume of the metering device 200 and the metering path 202 may have an enormous impact (which is here paralleled with a lever effect) on the actually metered volume of intaken sample fluid and can be a highly undesired source of inaccuracy, especially when operated under critical conditions.

In order to at least partially compensate for such artifacts, the control device 70 is configured for adjusting the drive mechanism 206 (shown only schematically in FIG. 2) driving the piston 208 of the metering device 200 within the piston chamber 210. The control device 70 is hence configured for at least partially compensating for the deviation by superposing a corrective piston movement during a process of drawing a metered amount of fluidic sample from the sample source 204 into fluid accommodation volume 212 (sample loop) of the metering path 202.

More specifically, the control device 70 is configured for adding a first corrective displacement for correcting artifacts based on volume changes of the internal volumes or spaces of the sample injector 40. Additionally, the control device 70 is configured for adding a second corrective displacement for correcting artifacts based on volume changes of the fluids within the sample injector 40. The first corrective displacement may be a backward displacement component or a forward displacement component. The second corrective displacement may be a backward displacement component or a forward displacement component.

The first corrective displacement may be a backward displacement component to the motion of the piston 208 in the piston chamber 210 in the event of a thermally induced decrease of the internal volume constrained by walls delimiting a fluid path in the sample injector 40. The first corrective displacement may be a forward displacement component to the motion of the piston 208 in the piston chamber 210 in the event of a thermally induced increase of the internal volume constrained by the walls delimiting the fluid path in the sample injector 40.

The second corrective displacement may be a backward displacement component to the motion of the piston 208 in the piston chamber 210 in the event of a thermally induced increase of the volume presently occupied by fluid in the sample injector 40. The second corrective displacement may be a forward displacement component to the motion of the piston 208 in the piston chamber 210 in the event of a thermally induced decrease of the volume presently occupied by the fluid in the sample injector 40.

An additional backward displacement (i.e. an additional motion component of the piston 208 in the direction indicated by arrow 262) will increase the volume of metered fluidic sample and can therefore compensate for a reduced intake (resulting from the artifact as described) of fluidic sample resulting from thermal expansion of the fluid content (see reference numerals 200, 202). Correspondingly, an additional forward displacement (i.e. an additional motion component antiparallel or opposite to the direction indicated by arrow 262) will decrease the volume of metered fluidic sample and can therefore compensate for an artificially large intake of fluidic sample resulting from thermal contraction of fluid content.

When the volumes of the fluidic conduits delimiting the sample injector 40 expand due to heating, the piston 208 moves to the inside (i.e. moves inwards with respect to the cylinder, or forwards). In contrast to this, an expansion of the present fluid content within the fluidic conduits as a consequence of heating requires that the piston 208 moves to the outside (i.e. moves outwards with respect to the cylinder, or backwards). However, when the volume of the fluidic conduits delimiting the sample injector 40 shrinks due to cooling, the piston 208 moves to the outside. In contrast to this, shrinkage or contraction of the present fluid content within the fluidic conduits as a consequence of cooling requires that the piston 208 moves to the inside. However, after the fluid has cooled rapidly due to pressure reduction, then the fluid gets heated back because it receives energy from the fluidic conduit which, in turn, is cooled subsequently. These effects may vary with the time. Furthermore, there may be, at each time, a superposition of multiple of the described effects which can be compensated for by the control device 70. The internal volume change will often be, under many circumstances, relatively small or will change in a shallow rate. The difference of the volume changes of the internal volume and of the fluid volume at the beginning and at the end of the intake is of relevance.

The control device 70 is furthermore configured for carrying out the compensation under consideration of thermal conductivity, heat capacitance, and coefficients of thermal expansion of the metering device 200, the metering path 202, the sample source 204, and the fluidic content (constituted by for instance 1 μl of the fluidic sample and approximately 100 μl of other fluids such as mobile phase) within the injector 40. When the fluidic sample is delivered in a cooled state, this lower temperature of the fluidic sample as compared to other fluids and the injector 40 can be disturbing for the accuracy of the metering, so that it is advantageous when this effect is compensated for. The control device 70 may use for this purpose data pre-stored in the database 95 shown in FIG. 1 concerning material and geometrical properties of the mentioned fluidic components and a model being indicative of an impact of thermal events and effects on these fluidic components. As a result of such a modelling, a prediction may be made to which extent an amount of metered fluid is manipulated by the mentioned thermal effects and events. It may then be calculated as to how a time dependence of the piston trajectory shall be adjusted or modified so as to partly or entirely compensate for the inaccurate metering. Thus, a continuous motion of the piston may be adjusted for compensation purposes which has the advantage that even during the procedure of driving the injection needle no fluid ejects from the injector or no air is drawn. Alternatively, the net amount of the discrepancy or deviation may be calculated, and may be compensated for by an extra motion before the injection needle drives out of the sample container. Alternatively the necessary correction may be pre-defined half-empirically or completely empirically for different sets of conditions and then used as reference or look-up database or tables.

In particular, the control device 70 can be configured for predicting an expected deviation of the amount of metered fluidic sample and for compensating for the expected deviation before its actual occurrence. Therefore, expected inaccuracies may be suppressed or eliminated before they actually develop. Alternatively, the control device 70 can detect a present deviation (or the conditions causing it to occur, such as exact temperature values, etc.) and can compensate for the present deviation to guide back the actual value of the amount of fluidic sample to the target value. For monitoring relevant parameters in the injector 40, one or more sensors 266, 268 may be arranged within the injector 40. In the shown embodiment, sensors 266 are temperature sensors monitoring the local temperature at the various positions of the injector 40. In contrast to this, sensors 268 are pressure sensors or flow sensors monitoring local pressure or flow rate at the various positions of the injector 40. Advantageously, one of the sensors 268 can be provided at the injection needle 256.

The control device 70 can also compensate for the deviation by effecting a pressure change in the metering device 200 acting against the thermally induced volume variation. Moreover, the control device 70 can also compensate for deviations based on a temperature over time characteristic of the metered fluidic sample. When this characteristic is known (for instance from a detection of corresponding sensor data), corresponding countermeasures can be taken. Moreover, the control device 70 can be configured for at least partially compensating for the deviation based on a time dependence of the thermally induced volume change within the sample separation apparatus 10. Such a time over volume artifact characteristic may be monitored (for instance, the pressure may be reduced in a closed state and the resulting time dependence of the pressure can be monitored in order to estimate characteristic time constants of the system) or modelled so that deviations changing over time can be suppressed.

With the described measures, it is possible to significantly increase accuracy of the sample intake and sample injection which, in turn, has a positive impact on the accuracy and precision of the sample separation by the liquid chromatography device constituting the sample separation apparatus 10.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

1. A method for controlling a metering device for metering a predefined amount of fluidic sample to be separated by a sample separation apparatus, the sample separation apparatus comprising the metering device, a sample source providing fluidic sample to be metered, a metering path, a fluid drive unit, and a separation unit configured for separating the fluidic sample into a plurality of fractions, the method comprising:
operating the sample separation apparatus in a high pressure separation state during which the metering path is fluidically coupled between the fluid drive unit and the separation unit, wherein the fluid drive unit drives a mobile phase and fluidic sample in the mobile phase to the separation unit under high pressure;
switching to operating the sample separation apparatus in a low pressure metering state during which the metering path is fluidically coupled with the metering device and the sample source, wherein the metering device intakes the fluidic sample from the sample source into the metering path under low pressure; and
controlling operation of the metering device for at least partially compensating for a deviation between a target value of an amount of fluidic sample to be metered and an actual value of an amount of fluidic sample that is metered, the deviation resulting from a thermally induced volume change in at least part of the sample separation apparatus due to a pressure change occurring when switching from the high pressure separation state to the low pressure metering state.

2. The method of claim 1, wherein controlling operation of the metering device comprises adjusting a drive mechanism for driving a piston of the metering device in a piston chamber for at least partially compensating for the deviation.

3. The method of claim 2, wherein controlling operation of the metering device comprises at least one of:
adding a backward displacement component to the motion of the piston in the piston chamber in the event of a thermally induced increase of the volume occupied by fluid in the metering device and the metering path;
adding a forward displacement component to the motion of the piston in the piston chamber in the event of a thermally induced decrease of the volume occupied by fluid in the metering device and the metering path;
adding a backward displacement component to the motion of the piston in the piston chamber in the event of a thermally induced decrease of the internal volume constrained by walls and/or boundaries of a fluid path in the metering device and the metering path;
adding a forward displacement component to the motion of the piston in the piston chamber in the event of a thermally induced increase of the internal volume constrained by walls and/or boundaries of a fluid path in the metering device and the metering path.

4. The method of claim 1, wherein the deviation results from a thermally induced volume change in a space within and a fluid occupied volume within the metering device and in the metering path.

5. The method of claim 1, wherein the control device is configured for carrying out the compensation under consideration of a property of a part of the sample separation apparatus selected from the group consisting of the metering device, the metering path, a sample loop in the metering path configured for accommodating the metered fluidic sample, and
wherein the property is selected from the group consisting of enthalpy, thermal conductivity, heat capacitance, coefficient of thermal expansion, and a combination of two or more of the foregoing.

6. The method of claim 1, comprising predicting an expected deviation and at least partially compensating for the expected deviation before its actual occurrence.

7. The method of claim 1, comprising detecting a present deviation and at least partially compensating for the present deviation to guide the actual value of the amount of metered fluidic sample towards the target value.

8. The method of claim 1, comprising at least partially compensating for the deviation by superposing a corrective piston movement before, after or during a process of drawing a metered amount of fluidic sample from the sample source into the metering path.

9. The method of claim 1, comprising at least partially compensating for the deviation under consideration of a temperature over time characteristic of all fluid being present in a sample injector of the sample separation apparatus, the sample injector comprising the metering device.

10. The method of claim 1, comprising at least partially compensating for the deviation under consideration of a temperature over time characteristic of at least one of the metered fluidic sample and at least a part of the sample separation apparatus.

11. The method of claim 1, comprising at least partially compensating for the deviation under consideration of a time dependence of a thermally induced volume change in a space within and in a fluid occupied volume within the sample separation apparatus.

12. The method of claim 1, comprising at least partially compensating for the deviation based on sensor data received from at least one sensor, wherein:
the at least one sensor is selected from the group consisting of: a temperature sensor; a pressure sensor; a flow rate sensor; and a flow or mass displacement sensor; and
the at least one sensor is disposed at a component selected from the group consisting of: the metering device; the metering path; and the sample source.

13. The method of claim 1, comprising at least partially compensating for the deviation based on a model indicative of the fluidic and energetic behavior of a component selected from the group consisting of: the metering device; the metering path; the fluidic sample; and the sample source.

14. The method of claim 1, comprising at least partially compensating for the deviation under consideration of a lever effect resulting from a difference between (a) an interior volume of the metering device and the metering path and (b) the metered volume of the fluidic sample.

15. The method of claim 1, comprising operating an injector valve to switch between the high pressure separation state and the low pressure metering state.

16. The method of claim 1, comprising operating the metering device to meter a volume of fluidic sample selected from the group consisting of: less than 50 μl; less than 10 μl; and less than 2 μl.

17. The method of claim 1, comprising at least partially compensating for a deviation of the amount of fluidic sample to be metered resulting from a thermally induced volume change of the fluidic sample.

18. The method of claim 1, wherein the thermally induced volume change occurs in a sample loop in the metering path configured for accommodating the metered fluidic sample.

19. A sample separation apparatus, comprising:
a fluid drive unit configured for driving a fluid comprising a mobile phase and the fluidic sample in the mobile phase along a separation path;
a separation unit arranged within the separation path and configured for separating the fluidic sample into a plurality of fractions; and
an injector configured for introducing the fluidic sample into the mobile phase between the fluid drive unit and separation unit, the injector comprising a metering device for metering fluidic sample and a control device configured for controlling the metering device according to the method of claim 1.

20. The sample separation apparatus according to claim 19, comprising at least one of the following features:
the sample separation apparatus is configured as a chromatography sample separation apparatus or an electrophoresis sample separation apparatus;
the sample separation apparatus comprises a detector configured to detect separated fractions of at least a portion of the fluidic sample;
the sample separation apparatus comprises a fractionating unit configured to collect separated fractions of the fluidic sample;
the control device is configured to process data related to the sample separation;
the sample separation apparatus comprises a degassing apparatus for degassing mobile phase;
the fluid drive unit is configured for driving the fluid along the separation path with a high pressure of at least 200 bar or at least 1000 bar.
